(19) United States
(12) Patent Application Publication
(10) Pub. No.: US 2024/0231462 A1
(43) Pub. Date: Jul. 11, 2024

(54) POWER MANAGEMENT IN INDUSTRIAL FIELD DEVICE

(71) Applicant: Rosemount Inc., Shakopee, MN (US)

(72) Inventors: Matthew Then, Plymouth, MN (US); Mehul Rajeshbhai Dalal, Pune (IN)

(21) Appl. No.: 18/406,633

(22) Filed: Jan. 8, 2024

Related U.S. Application Data
(60) Provisional application No. 63/479,251, filed on Jan. 10, 2023.

(51) Int. Cl. G06F 1/3206

(52) U.S. Cl. CPC G06F 1/3206

(57) ABSTRACT

A field device for use in an industrial process includes a transducer configured to couple to the industrial process and control or monitor a process variable of the industrial process. Primary communication circuitry communicates information with a remote location related to the process variable. A wireless communication module includes an energy storage device and power monitoring electronics coupled to the energy storage device having a power output and a power status output. Wireless communication circuitry of the wireless communication module is configured to communicate wirelessly and perform a plurality of high priority tasks and a plurality of low priority tasks. The high priority tasks are performed asynchronously and the plurality of low priority tasks are only performed if the power status output indicates that there is sufficient power.

### CROSS-REFERENCE TO RELATED APPLICATION

The present application is based on and claims the benefit of U.S. provisional patent application Ser. No. 63/479,251, filed Jan. 10, 2023, the content of which is hereby incorporated by reference in its entirety

### BACKGROUND

The present invention relates to industrial process control or monitoring systems. More specifically, the present invention relates to field devices in such systems that include wireless communication abilities.

In industrial settings, control systems are used to monitor and control inventories of industrial and chemical processes, and the like. Typically, the control system performs these functions using field devices distributed at key locations in the industrial process and coupled to the control circuitry in the control room by a process control loop. The term “field device” refers to any device that performs a function in a distributed control or process monitoring system, including all devices currently known, or yet to be known, used in the measurement, control and monitoring of industrial processes.

Some field devices include a transducer. A transducer is understood to mean either a device that generates an output signal based on a physical input or that generates a physical output based on an input signal. Typically, a transducer transforms an input into an output having a different form. Types of transducers include various analytical equipment, pressure sensors, thermistors, thermocouples, strain gauges, flow transmitters, positioners, actuators, solenoids, indicator lights, and others.

Typically, each field device also includes communication circuitry that is used for communicating with a process control room, or other circuitry, over a process control loop. In some installations, the process control loop is also used to deliver a regulated current and/or voltage to the field device for powering the field device. The process control loop also carries data, either in an analog or digital format.

Traditionally, analog field devices have been connected to the control room by two-wire process control current loops, with each device connected to the control room by a single two-wire control loop. Typically, a voltage differential is maintained between the two wires within a range of voltages from 12-45 volts for analog mode and 9-50 volts for digital mode. Some analog field devices transmit a signal to the control room by modulating the current running through the current loop to a current proportional to the sensed process variable. Other analog field devices can perform an action under the control of the control room by controlling the magnitude of the current through the loop. In addition to, or in the alternative, the process control loop can carry digital signals used for communication with field devices. Digital communication allows a much larger degree of communication than analog communication. Field devices that communicate digitally can respond to and communicate selectively with the control room and/or other field devices. Further, such devices can provide additional signaling such as diagnostics and/or alarms.

In some installations, wireless technologies are used to communicate with field devices. Wireless operation simplifies field device wiring and setup. Completely wireless installations are currently used in which the field device is designed to use a battery, solar cell, or other technique to obtain power without any sort of wired connection. However, the majority of field devices are hardwired to a process control room. In such hard-wired devices, it can still be desirable to provide wireless communication. This can be used for diagnostics, obtaining readings by an operator located in the field, or for device configuration. However, the wireless communication circuitry requires power for operation. This power requirement is in addition to the power used to run other circuitry in the device. If the wireless communication circuitry exceeds its power budget, operation of the field device can fail and the device can go off-line.

### SUMMARY

A field device for use in an industrial process includes a transducer configured to couple to the industrial process and control or monitor a process variable of the industrial process. Primary communication circuitry communicates information with a remote location related to the process variable. A wireless communication module includes an energy storage device and power monitoring electronics coupled to the energy storage device having a power output and a power status output. Wireless communication circuitry of the wireless communication module is configured to communicate wirelessly and perform a plurality of high priority tasks and a plurality of low priority tasks. The high priority tasks are performed asynchronously and the plurality of low priority task are only performed if the power status output indicates that there is sufficient power.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view of an exemplary industrial process control field device including a wireless communication module.

FIG. 2 is a block diagram of the field device shown in FIG. 1.

FIG. 3 a graph of voltage versus time showing voltage levels.

FIG. 4 is a diagram which illustrates operation of the energy management system for the wireless communication module.

FIG. 5 is a graph of energy level versus time while compute tasks are performed by the wireless communication module.

FIG. 6 is a flow chart showing execution of compute tasks in accordance with the graph of FIG. 5.

FIG. 7 is a graph of stored energy level versus time for the system while RF communication is disabled.

FIG. 8 is a graph of stored energy level versus time while an advertising radio event is performed.

FIG. 9 is a graph of stored energy level versus time while a connection radio event is performed.

FIG. 10 is a simplified block diagram of the field device of FIG. 1 showing the wireless communication module in more detail.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

The present invention includes an industrial process control field device having a transducer configured to control or monitor a process variable of an industrial process. The device includes primary communication circuitry which communicates information related to the process variable. A wireless communication module is configured for wireless communication using wireless communication circuitry and is powered with power stored in an energy storage device. Power monitoring electronics monitors available power and/or power usage. The power can be determined by measuring the voltage of the energy storage device or through some other means. Tasks performed by the wireless communication module are controlled based up on an output from the power monitoring electronics.

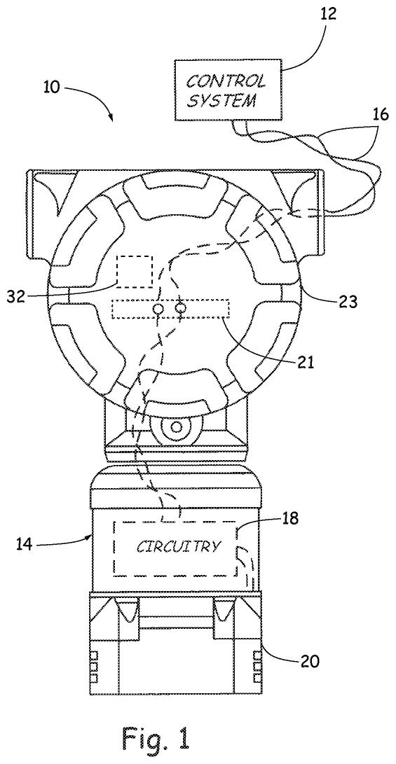

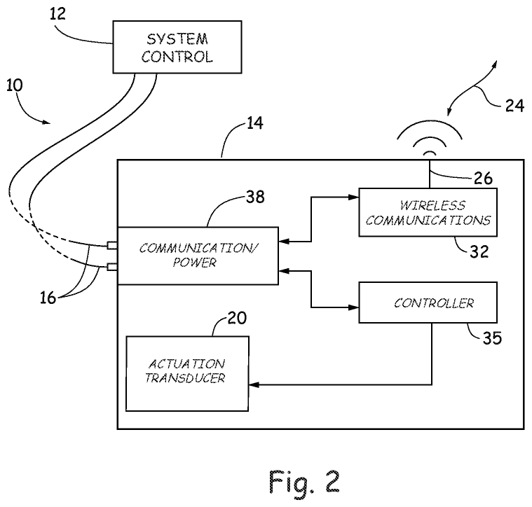

FIGS. 1 and 2 are diagrammatic and block diagram views of an exemplary field device 14 which include a wireless communication module 32 in accordance with the present invention. Process control or monitoring system 10 includes a control room or control system 12 that couples to one or more field devices 14 over a two-wire process control loop 16. Examples of process control loop 16 include analog 4-20 mA communication, hybrid protocols which include both analog and digital communication such as the Highway Addressable Remote Transducer (HART®) standard, as well as all-digital protocols such as the FOUNDATION™ Fieldbus standard, Ethernet APL (Advanced Physical Layer), and others. Generally, process control loop protocols can both power the field device and allow communication between the field device and other devices. Further, process control loop 16 can comprise a wireless process control loop such as those in accordance with WirelessHART® (IEC 62591) or ISA 100.11a (IEC 62734), or another wireless communication protocol, such as WiFi, LoRa, Sigfox, BLE, or any other suitable protocol including a custom communication protocol. As used herein, this is referred to as primary communication circuitry 38.

Field device 14 includes circuitry 18 coupled to actuator/transducer 20 and to process control loop 16 via terminal board 21 in housing 23. Field device 14 is illustrated as a process variable (PV) sensor in that it couples to a process and senses an aspect, such as temperature, pressure, level, pH, flow, etc. of the process and provides an indication thereof. Other examples of field devices include valves, actuators, controllers, and displays.

Generally, field devices are characterized by their ability to operate in the “field” which may expose them to environmental stresses, such as temperature, humidity and pressure. In addition to environmental stresses, field devices must often withstand exposure to corrosive, hazardous and/or even explosive atmospheres. Further, such devices must also operate in the presence of vibration and/or electromagnetic interference.

Field device 14 includes internal primary communication/power supply module 38, controller 35, wireless communication module 32, and actuator/transducer 20. Communication/power supply module 38 may couple to an auxiliary power source or include a battery that powers field device 14. Some field devices include a built-in solar cell. Further, the power can also be provided from a wired process control loop 16, or from another external source including solar panels. The power from supply 38 energizes controller 35 to interact with actuator/transducer 20 and wireless communications module 32. Wireless communications module 32, in turn, interacts with other devices as indicated by reference numeral 24 via antenna 26. Depending upon the application, wireless communication module 32 may be adapted to communicate in accordance with any suitable wireless communication protocol including, but not limited to: wireless networking technologies (such as IEEE 802.11b wireless access points and wireless networking devices built by Linksys of Irvine, California), Bluetooth® (BLE), cellular or digital networking technologies (such as Microburst® by Aeris Communications Inc. of San Jose, California), ultra wide band, free space optics, Global System for Mobile Communications (GSM), General Packet Radio Service (GPRS), Code Division Multiple Access (CDMA), spread spectrum technology, infrared communications techniques, SMS (Short Messaging Service/text messaging), or any other suitable wireless technology. Further, known data collision technology can be employed such that multiple units can coexist within wireless operating range of one another. Such collision prevention can include using a number of different radio-frequency channels and/or spread spectrum techniques.

Wireless communication module 32 can also include transducers for a plurality of wireless communication methods. For example, wireless communication could be performed using relatively long distance communication methods, such as GSM or GPRS, while a secondary, or additional communication method could be provided for technicians, or operators near the device, using, for example, IEEE 802.11b or Bluetooth.

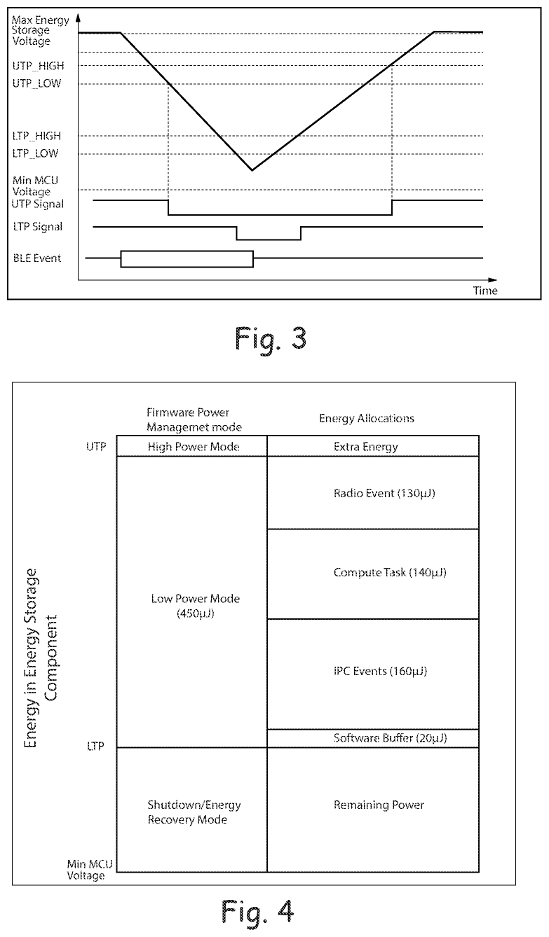

One technique for managing power requirements for a wireless communication module is disclosed in US20190246353A entitled Methods and Apparatus for Control Communication Data rates of Low-Energy Devices assigned to Fisher Controls International LLC which is hereby incorporated by reference in its entirety. FIG. 3 shows a graph of voltages versus time for such a configuration. As illustrated in FIG. 3, an energy storage device recharges based on the input current provided to the wireless communication module and discharges based on a specific task or process that the module executes. The voltage drop shown in FIG. 3 is based on a Bluetooth® event.

In FIG. 3, UTP is an upper trip point where the energy storage device is substantially fully charged. Upon reaching such a state, a GPIO (General Purpose I/O) line to the controller is used to indicate that the voltage level is high. If this is not the case, the GPIO line goes low when the voltage level goes below UTP. The LTP is a lower trip point where the energy storage is nearly fully depleted, and another GPIO line goes from high to low in such instance.

One technique which can be used to manage power for the communication module uses a Kalman filter (linear quadratic estimator) to estimate energy stored in the energy storage device and responsively control power usage by the communication module 32. The Kalman filter is used to estimate discharge and recharge rates during operation. The communication module performs multiple computation tasks depending on the available energy approximation determined by the Kalman filter. Further, a single computation task can be performed multiple times based on the estimated stored energy. If the estimated stored power is sufficient, the communication module can enable its radio for connection to a remote device.

In such a configuration, the discharge and recharge rates are estimated based on historical rates. However, the input current provided to the communication module may vary, leading to inaccuracies in the estimation of stored energy. As an example, the energy storage device will be recharged faster when the field device 14 is coupled to HART® loop current 16 operating at 20 mA which allows the DC power source of the main board in the field device to supply a higher current to the communication module 32. However, based on such approximation, later if the loop current changes to minimum value i.e., 3.5 mA, the recharge rate of the energy storage device will drop to a significant lower value. This may cause the voltage of the energy storage unit to reach the lower voltage point (LTP) and eventually the Minimum MCU Voltage resulting in a brown out condition in which the communication module is reset. Further, if such an estimation is used to schedule execution of compute tasks, the throughput may be inconsistent if the energy being provided to the communication module is dynamically changing.

The present invention provides a power management system for a communication module 32 in a field device 14 that remains independent of the operating mode of the device, whether it is loop powered energy and has power constraints or if it is a device having an auxiliary power source. The system manages power usage for various tasks performed by the communication module including radio operation (transmit and/or receive), inter processor communication (IPC) and compute tasks. When the process control loop is operating at a low current level, a loop powered device can only deliver a small amount of power to the communication module. For example, as little as 300 uA of input current to the communication module operating at 4.3V, i.e., 1.29 mW power. The input current can be higher if the loop is operating at a higher current level, resulting in the communication module 32 receiving much more current, for example, 4 mA of input current. The communication module 32 includes an energy storage device such as a storage capacitor, which is recharged based on the input current to the module and discharged based on the quiescent current used by the module 32. For example, if a microcontroller of the module is active, the module can consume as much as 10 mA of current when the radio is actively transmitting at 5 dBm transmit power. Further, apart from the radio itself, the microcontroller can consume a higher current level depending on the number of active peripherals.

The power management system of the present invention controls operation of various tasks performed by the communication module 32. There are various operations being performed by the microcontroller and radio circuitry which can consume energy. These are referred to herein as energy consumption activities and include:
Radio operation: The radio circuitry must transmit and/or receive when the radio of the communication module is advertising its availability, or in communication with another device.
IPC (inter processor communication) message exchange: The microcontroller of the wireless communication module communicates with the microcontroller of the field device, for example exchanging the data using SPI, UART, or I2C communications.
Compute tasks: these are tasks performed by the microcontroller of the wireless communication module when executing a specific procedure. These procedures may be related to:
   Running a cryptographic algorithm for security operations, for example random number generation or other tasks related to encryption and decryption.
   Storing data into an external non-volatile memory device.
   Updating firmware.

The power management system preferable operates with both loop powered and externally (auxiliary) powered devices. The power management system assumes the following, irrespective of the mode of the device power (loop powered or auxiliary powered):
A minimum input current provided to the communication module 32 is at least above a minimum threshold. A higher loop current or an auxiliary power source can provide a higher recharge rate of the energy storage device. However, the power management system assumes that the recharging occurs at the lower rate.
Compute tasks performed by the microcontroller of the communication module are executed in a round-robin fashion, one at a time, and each run until all the tasks have been completed. Such compute tasks have predefined worst case energy consumption values. For example, asymmetric encryption with any single iteration as a compute task consumes no more than 140 uJ of energy.
The energy management system does not rely on the discharge rate while executing any of the energy consumption tasks. Instead, the system assumes that the energy consumed by these energy consumption tasks are at most 140 uJ for each task in a single iteration. With this technique, no firmware runtime discharge rate calculation is required.
   In this configuration, security and firmware update compute tasks are divided into multiple iterative functions in which a single iteration energy consumption is less than 140 uJ.

FIG. 4 is a diagram which illustrates operation of the energy management system of the invention. FIG. 4 illustrates operation of various tasks as they relate to available energy stored in the energy storage device. An upper trip point (UTP) and a lower trip point (LTP) are illustrated. The tasks illustrated include a radio event, a compute task, and IPC event. A software buffer is also illustrated and provides an energy reserve before the LTP is reached and the system enters shutdown mode. When fully charged, the energy storage device stores a minimum amount of energy as desired for a particular implementation, for example, 500 uJ in one specific configuration. If the field device 14 is powered from an external auxiliary power source, the energy management system will operate in high power mode.

The energy management system does not use an estimation of current recharge rate based on approximated model based on past samplings (for example, a Kalman filter). Instead, the energy management system operates based upon time and waits for the stored energy to reach the Upper Trip Point after execution of an energy consumption task.

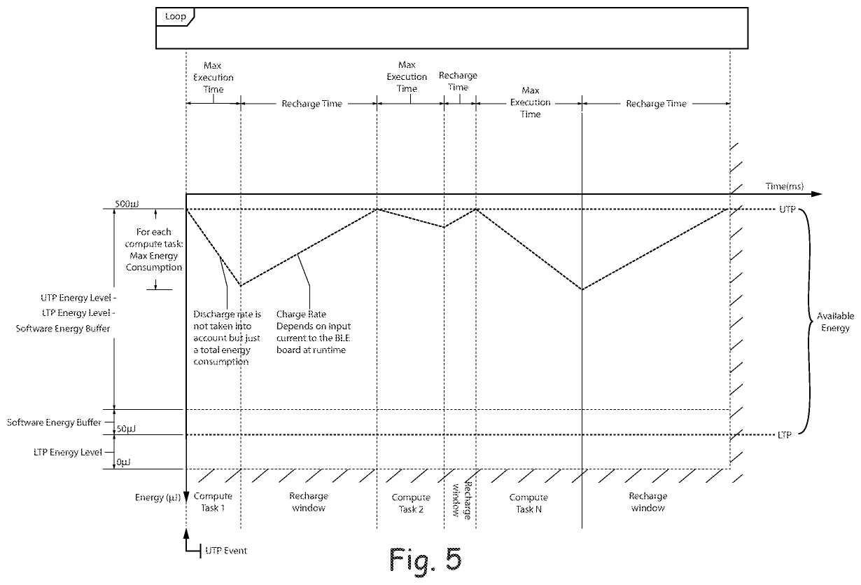

FIG. 5 is a graph of stored energy versus time showing energy discharge as a result of performing various tasks, as well as recharging. As shown in FIG. 5, the discharge rate during operation is not calculated by the device. Instead, the worst case energy consumption amount is deducted as a static parameter. This also assumes that there is no recharging that occurs while the task is executing.

Once the task execution is completed, the energy management system waits for the energy storage unit to recharge to the UTP level. Further, the microcontroller can be placed in a deep sleep mode during this recharge time. Thus, depending on the recharge rate at the runtime, the stored energy can reach UTP in less time at a higher recharge rate or take a longer time if the recharge rate is lower (for example, a predetermined minimum recharge rate). The system waits for stored charge to reach the UTP level at which time the controller can be woken up by using the UTP line as a GPIO line and a next task can be initiated.

The energy management system preferably does not allow the energy level to reach to the LTP level. If the LTP energy level is reached, the system considers this to be a fail condition, and it immediately places the microcontroller into a deep sleep mode. This allows the system to recover from the lowest energy level without causing a brown out of the microcontroller.

In one example configuration, the energy between the UTP and LTP levels is 450 uJ. This energy budget allows execution of both synchronous energy consumption tasks (low priority tasks) and asynchronous energy consumption tasks (high priority tasks) as follows:
Synchronous energy consumption tasks (scheduled events):
   Radio events of advertising and connection. Advertising occurs periodically at a desired frequency. Connection events are also periodic and can use a negotiated time between a host and a client device.
   Compute tasks in round-robin schedule.
      For each synchronous event, the power management system waits for the UTP level to be reached. Once the UTP level is reached, the next synchronous event is executed.
Asynchronous energy consumption tasks (unscheduled events), can occur at any time and are executed as follows:
   IPC (Interprocessor Communication)
      The Asynchronous events are executed using a pre-budgeted amount of energy from the available energy stored in the energy storage device. For example, 160 uJ of energy shown in FIG. 4. After the IPC event, the energy storage unit is allowed to recover this pre-budgeted amount of energy before a subsequent IPC event is allowed to occur.

A field device with an auxiliary power source will not discharge below the UTP power level. For such a device, a UTP event is triggered immediately. The algorithm after executing any energy consumption tasks in both loop powered and auxiliary powered devices is as follows:
Determine the state of the energy storage.
   If not high, wait for the UTP level to be reached
Else
   Set a UTP high event in the case of a field device with an auxiliary power source.

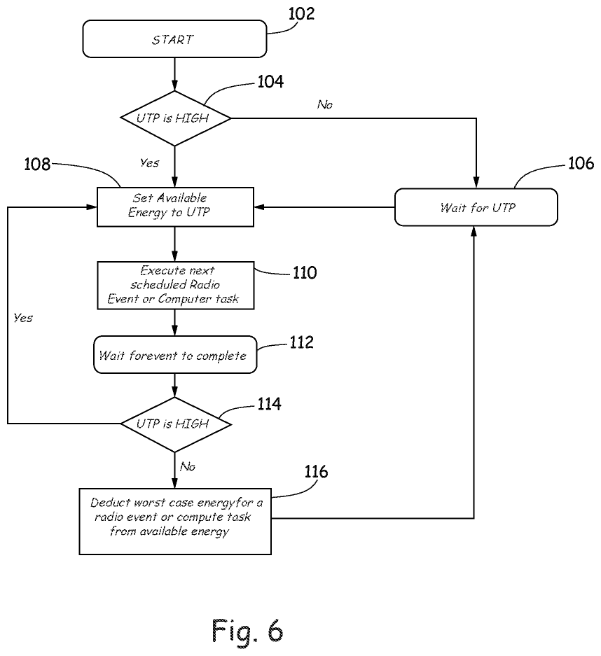

FIG. 6 is a simplified flow chart 100 of steps used by the power management systems in accordance with one example configuration. The process begins at block 102. At block 104, the UTP state is checked. If UTP is not high, the system waits for UTP high at block 106. At block 108, the available energy is set to the UTP level and control is passed to block 110 where the next scheduled radio event or compute task is executed. At block 114, the UTP level is checked. If UTP is high, control is passed to block 108. If UTP is not high, control is passed to block 116 where the worst case (maximum) energy consumption amount for a radio event or a compute task is subtracted from the available energy and control is returned to block 106 for the process to repeat. This allows the power management system to be used with both loop powered and auxiliary powered field devices.

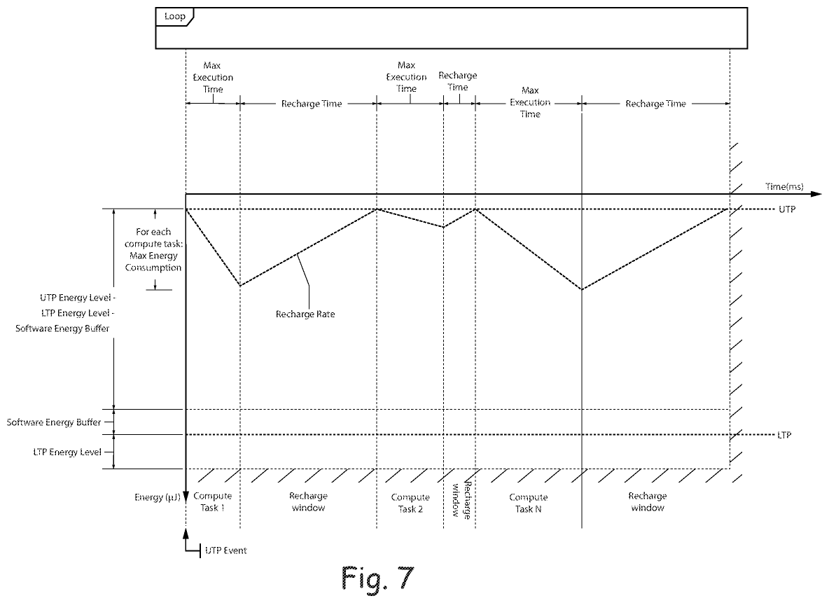

FIG. 7 is a graph of stored energy level versus time for the system while radio communication is disabled. Each compute task is executed and run to completion in round-robin sequence. The system waits for the stored power to recover to the UTP level between each compute task.

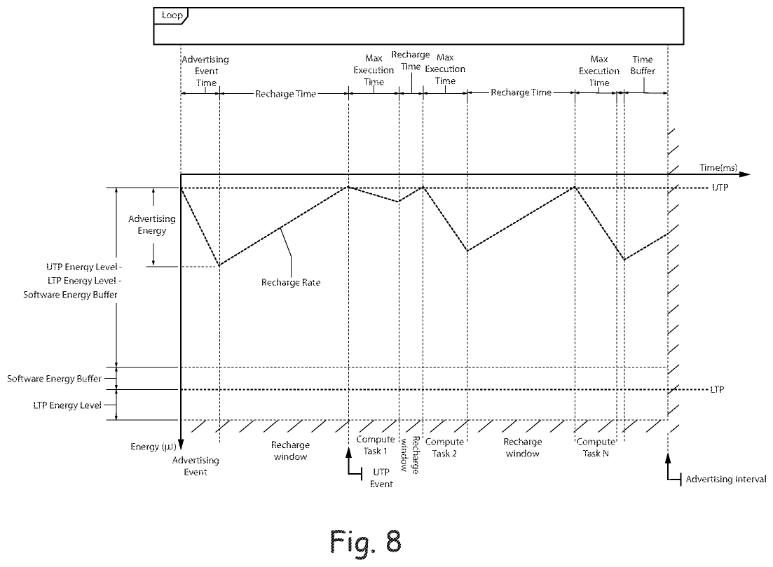

FIG. 8 is a graph of stored energy level versus time while an advertising radio event is performed. An advertising radio event is performed when the communication module is transmitting a signal which indicates it is available for communication. Operation during an advertising radio event is as follows:
Advertising: A compute task is executed only if:
   There is sufficient energy to execute the selected compute task AND
   The amount of time required for the selected compute task to complete and for the storage device to recover the energy spent is less than the time until the next advertising event starts OR
   There is sufficient energy to execute the selected compute task and the next advertising event AND
   The compute task will complete before the next advertising event.

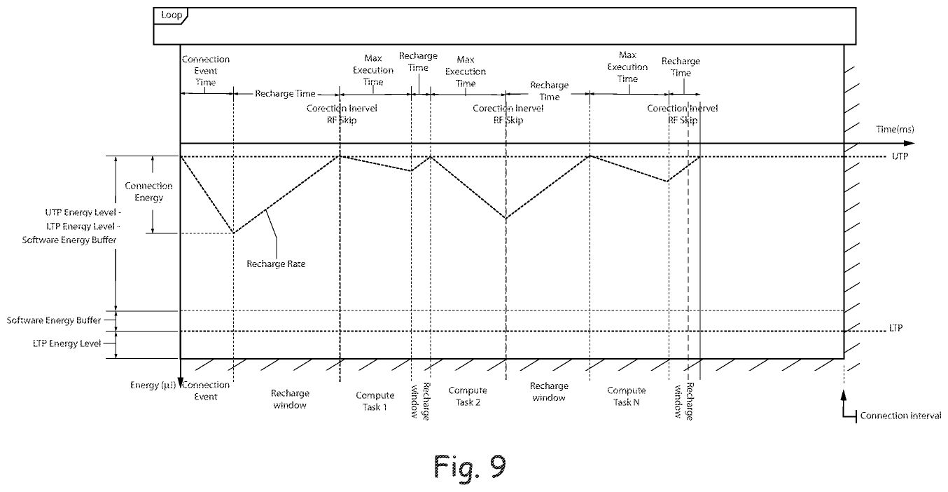

FIG. 9 is a graph of stored energy level versus time while a connection radio event is performed. After each connection radio event completes, the system disables further operation of the radio to reduce the energy consumption such that any subsequent compute tasks can be performed.
The firmware executes individual compute tasks and continues if:
   There is enough energy to execute the selected compute task
   —OR—
   There are compute tasks remaining to be executed in a list (round-robin sequence) of compute tasks to execute
After one of the checks above fails, the system then pauses further compute task execution until a UTP high level is detected.
Once the energy storage reaches the UTP level, the system checks to determine if there are any remaining compute tasks to be executed from the list of compute tasks.
   If there are further compute tasks, the system executes the next selected compute task.
   If all the compute tasks in the list have been executed, the system then waits for a UTP high to be detected, after which the system enables the radio to allow the next radio connection event to occur. The system then returns to the first bullet above.

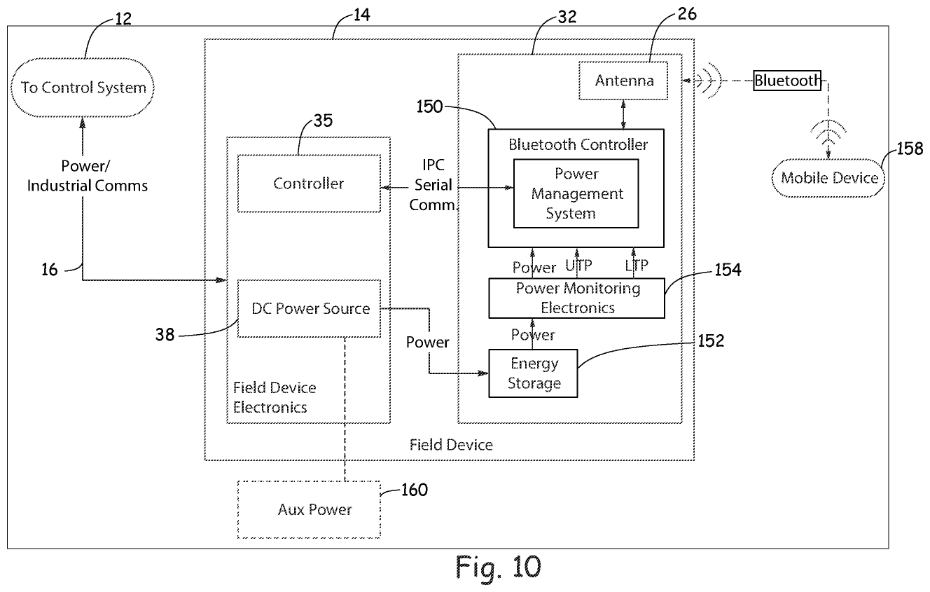

FIG. 10 is a simplified block diagram of field device 14 showing communication module 32 in more detail. Module 32 includes a Bluetooth microcontroller (radio) 150 which is in communication with the microcontroller 35 of the field device electronics over an IPC communication link. Microcontroller 150 includes radio circuitry coupled to antenna 26 for communicating with a local mobile device such as a hand held communicator 158 or the like. Microcontroller 150 operates in accordance with instructions stored in an internal memory and provides the power management system discussed above. Power is received from DC power source 38 and stored in energy storage device 152. Energy storage device 152 may comprise any appropriate storage device, such as a capacitor or a battery. Power monitoring electronics 154 monitors the power stored in energy storage device 152 and provides power to the microcontroller 150 along with the UTP and LTP signals. The UTP and LTP signals can be determined based upon voltage thresholds, for example. Field device 14 can be powered with power received from process control loop 16 or from an optional auxiliary power source 160.

The power management system set forth herein provides a number of advantages. The system does not rely on approximation of stored power based on past based data for discharge and recharge rates, which can have substantial variations from the actual rates. Further, the same power management system can be used for both auxiliary powered and loop powered field devices. The system addresses runtime changes in the discharge and recharge rates by assuming:
For discharging, the worst case (maximum) discharge energy for any energy consumption task.
For recharging, the system waits for the stored energy to reach the UTP level such that for greater recharge rates, the stored energy will reach UTP sooner.
The system provides a power profile that is capable of quickly reacting to changing energy conditions. This provides more robust radio communication.

Although the present invention has been described with reference to preferred embodiments, workers skilled in the art will recognize that changes may be made in form and detail without departing from the spirit and scope of the invention.

What is claimed is:

1. A field device for use in an industrial process, comprising:
a transducer configured to couple to the industrial process and control or monitor a process variable of the industrial process;
primary communication circuitry configured to communicate information with a remote location related to the process variable;
a wireless communication module comprising:
an energy storage device;
power monitoring electronics coupled to the energy storage device and having a power output and a power status output; and
wireless communication circuitry configured to communicate wirelessly and perform a plurality of high priority tasks and a plurality of low priority tasks, wherein the high priority tasks are performed asynchronously and the plurality of low priority task are only performed if the power status output indicates there is sufficient power.

2. The field device of claim 1 wherein the low priority tasks are performed synchronously in a round-robin schedule.

3. The field device of claim 2 wherein the wireless communication circuitry includes a microcontroller and the low priority tasks include compute tasks performed by the microcontroller.

4. The field device of claim 3 wherein the compute tasks are performed synchronously based on an amount of energy stored in the energy storage device.

5. The field device of claim 2 wherein the wireless communication circuitry includes a radio and low priority tasks include radio events performed by the radio.

6. The field device of claim 5 wherein radio events include an advertising event.

7. The field device of claim 6 wherein the wireless communication circuitry includes a microcontroller and the low priority tasks include compute tasks performed by the microcontroller and a compute task is performed if there is sufficient energy stored in the energy storage device to complete the compute task and an amount of time required to complete the compute task and an amount of time for the energy storage device to recover energy used by the compute task is less than an amount of time until a next advertising event.

8. The field device of claim 6 wherein the wireless communication circuitry includes a microcontroller and the low priority tasks include compute tasks performed by the microcontroller and a compute task is performed if there is sufficient energy stored in the energy storage device to complete both the compute task and a next advertising event and the compute task will complete before the next advertising event.

9. The field device of claim 5 wherein radio events include a connection radio event.

10. The field device of claim 9 wherein the wireless communication circuitry includes a microcontroller and the low priority tasks include compute tasks performed by the microcontroller and a connection radio event is not performed until all of the compute tasks are complete and there is sufficient energy stored in the energy storage device is above an upper trip point level.

11. The field device of claim 5 wherein the wireless communication circuitry includes a microcontroller and the low priority tasks include compute tasks performed by the microcontroller, and wherein the radio is disabled while compute tasks are performed.

12. The field device of claim 1 including a field device microcontroller and wherein the wireless communication circuitry includes a microcontroller and the high priority tasks include interprocessor communication between the microcontroller and the field device microcontroller.

13. The field device of claim 12 wherein interprocessor communication is performed if energy stored in the energy storage device is above an upper trip point level.

14. The field device of claim 13 wherein a subsequent interprocessor communication is performed if energy from prior interprocessor communication is recovered.

15. The field device of claim 1 wherein the primary communication circuitry couples to a two wire process control loop and the field device is powered with power received from the two wire process control loop.

16. The field device of claim 1 including a connection to an auxiliary power source and wherein the field device is powered with power from the auxiliary power source.

17. The field device of claim 16 wherein an upper trip point level is set to a high condition.

18. The field device of claim 1 wherein the energy storage device comprises a capacitor.

19. The field device of claim 1 wherein the power status output of the power monitoring electronics comprises an upper trip point output and a lower trip point output.

20. The field device of claim 1 wherein the power status output of the power monitoring electronics is determined based upon voltage of the energy storage device.
